(19) United States
(12) Patent Application Publication
(10) Pub. No.: US 2016/0016480 A1
(43) Pub. Date: Jan. 21, 2016

(54) METHOD AND SYSTEM FOR CONTROLLING ELECTRIC VEHICLES

(71) Applicant: Hyundai Motor Company, Seoul (KR)

(72) Inventors: Do Hoon Kim, Seoul (KR); Zeung Il Kim, Hwaseong, Gyeonggi-Do (KR)

(21) Appl. No.: 14/534,946

(22) Filed: Nov. 6, 2014

(30) Foreign Application Priority Data
Jul. 15, 2014 (KR) 10-2014-0088916

(51) Int. Cl. B60L 11/18; B60H 1/00; H02J 7/02

(52) U.S. Cl. CPC B60L 11/1846; H02J 7/025; B60L 11/182; B60H 1/00385; B60H 1/00735

(57) ABSTRACT

A method and a system for controlling electric vehicles are provided. The method for includes wirelessly authenticating, by the controller, a vehicle and a charger when the vehicle enters stops in the network area of the charger. When the authentication is completed, the controller receives reservation information set from the charger and vehicle and wirelessly performs charging or air conditioning based on the received reservation information.

### CROSS REFERENCE(S) TO RELATED APPLICATIONS

The present application claims priority of Korean Patent Application Number 10-2014-0088916 filed on Jul. 15, 2014, which is incorporated herein by reference in its entirety.

### BACKGROUND

1. Technical Field

The present invention relates to a method and a system for controlling electric vehicles, and more particularly, to a method and a system for controlling electric vehicles capable of performing wireless charging or air conditioning by receiving reservation charging information or reservation air conditioning information via wireless communication when a vehicle enters a network area set by a charger.

2. Description of the Related Art

Recently, plug-in hybrid and electric vehicle technologies have been rapidly developing. Some or all of the driving power of these vehicles is electrical energy. Therefore, when the energy stored in a battery is consumed, the amount of electrical energy consumed for air conditioning should be reduced to improve fuel efficiency of a vehicle and the battery recharged at a charging station. These charging stations have a charging stand and a power cable connected to the charging stand used to charge the vehicle battery.

Related control systems disclose a reservation charging function and a reservation air conditioning function. These control systems relate to an apparatus for informing a driver outside a vehicle of reservation conditions and vehicle conditions. However, the above system only discloses a charging reservation setting unit for setting reservation performing the charging of the battery to set a charging start time. In other words, the reservation charging is performed only by information regarding the charging start time set in either the vehicle or the charger.

The development of a smart grid technology allows a vehicle and a charger to share the information about the reservation time as well as other information, which is disposed in the vehicle and the charger, to charge the vehicle depending on an optimal reservation charging time and a charging potential amount are required.

### SUMMARY

An objective of the present invention provides a method and a system for controlling electric vehicles capable of performing wireless charging or air conditioning by receiving reservation charging or air conditioning information via wireless communication when a vehicle enters a network area set by a charger.

According to an exemplary embodiment of the present invention, a method for controlling electric vehicles may include: authenticating the vehicle and a charger wirelessly when the vehicle enters or stops in a charger network area; when the authentication is completed, receiving reservation information set from the charger and the vehicle, respectively; and performing wireless charging or air conditioning based on the received reservation information. The reservation information received from the authenticated vehicle and the charger may include at least one of initial state of charge (SOC) information and reservation time information. The wireless charging or air conditioning may be performed based on priority information received from the charger and the vehicle or a receiving time of the reservation information. The priority may also change depending on priority information preset by a driver. The authentication of the vehicle and the charger may use preset identifiers, which may be disposed in both the vehicle and charger.

The wireless charging or air conditioning of the vehicle may include receiving required information from both the charger and the vehicle based on preset operation modes after the wireless charging or air conditioning is performed. The required information may include at least one of an external temperature, a charging efficiency, a required current and voltage, an electricity usage of other electric devices using the same power source as the charger, a midnight electricity availability, a maximum charging current, and a required charging time.

The method may further include: turning off a starting condition of wireless charging or air conditioning, after the receiving of the reservation information. The wireless charging or air conditioning may then be performed based on the reservation information when a starting condition of the wireless charging or air conditioning is satisfied. The starting condition may include information regarding whether the vehicle is in a reservation charging time or a reservation air conditioning time, or whether a battery is charged less than a preset level. Additionally, the method may further include: performing the wireless charging or air conditioning of the vehicle based on the reservation information received in the receiving when the vehicle again enters t the charger network area.

The performing of the wireless charging or air conditioning of the vehicle may include calculating a wireless charging efficiency. The wireless charging efficiency may be calculated by an electrical energy supplied to the vehicle divided by required electrical energy transferred from the vehicle to the charger and electrical energy used to charge the vehicle. The wireless charging or air conditioning of the vehicle may further include retransmitting required electrical energy determined based on the calculated wireless charging efficiency and the temperature of the vehicle.

While wireless charging or air conditioning of the vehicle is performed, the performance may be controlled by a performance time of the wireless charging and an electrical energy used to perform the wireless charging or air conditioning based on received electrical charging information or other load electrical energy use information.

According to an exemplary embodiment of the present invention, a system for controlling electric vehicles, may include: a charger having a network area to wirelessly communicate with a vehicle and configured to charge the vehicle; an input unit configured to receive a command from a driver; and a controller configured to execute communication between the vehicle and the charger and wireless charging and air conditioning of the vehicle. The controller may be configured to authenticate the vehicle and the charger when the vehicle enters the network area or stops in the network area and receives reservation information set from the charger and the vehicle, respectively, and when authentication is completed, may be configured to execute the wireless charging and air conditioning of the vehicle.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplary diagram schematically illustrating a system for controlling electric vehicles according to an exemplary embodiment of the present invention; and

FIG. 2 is an exemplary flow chart illustrating a method for controlling electric vehicles according to an exemplary embodiment of the present invention.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Specifically structural and functional descriptions in exemplary embodiment of the present invention disclosed in the present specification or the present application are illustrated to describe exemplary embodiments of the present invention and therefore, the exemplary embodiments of the present invention may be practiced in various forms and are not to be construed as being limited to the exemplary embodiment of the present invention disclosed in the present specification or the present application.

The exemplary embodiments of the present invention may be variously modified and have various forms and therefore specific exemplary embodiments are illustrated in the accompanying drawings and will be described in detail in the present specification or the present application. However, it is to be understood that the present invention is not limited to the specific exemplary embodiments, but includes all modifications, equivalents, and substitutions included in the spirit and the scope of the present invention.

Terms such as ‘first’, and/or ‘second’, etc., may be used to describe various components, but the components are not to be construed as being limited to the terms. The terms are used only to distinguish one component from another component. For example, the ‘first’ component may be named the ‘second’ component and the ‘second’ component may also be similarly named the ‘first’ component, without departing from the scope of the present invention.

It is to be understood that when one element is referred to as being “connected to” or “coupled to” another element, it may be connected directly to or coupled directly to another element or be connected to or coupled to another component, having the other component intervening therebetween. On the other hand, it is to be understood that when one element is referred to as being “connected directly to” or “coupled directly to” another component, it may be connected to or coupled to another element without the other component intervening there between. Other expressions describing a relationship between components, that is, “between”, “directly between”, “neighboring to”, “directly neighboring to” and the like, should be similarly interpreted.

Unless indicated otherwise, it is to be understood that all the terms used in the specification including technical or scientific terms have the same meaning as those that are generally understood by those skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in detail with reference to the accompanying drawings. Like reference numerals proposed in each drawing denote like components.

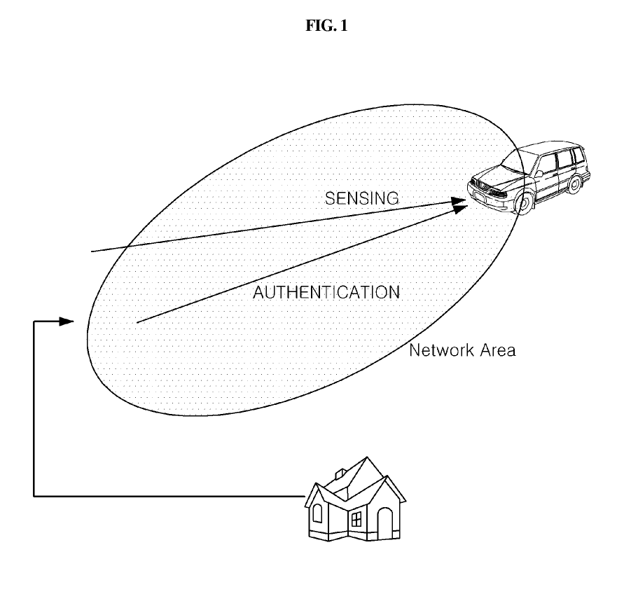

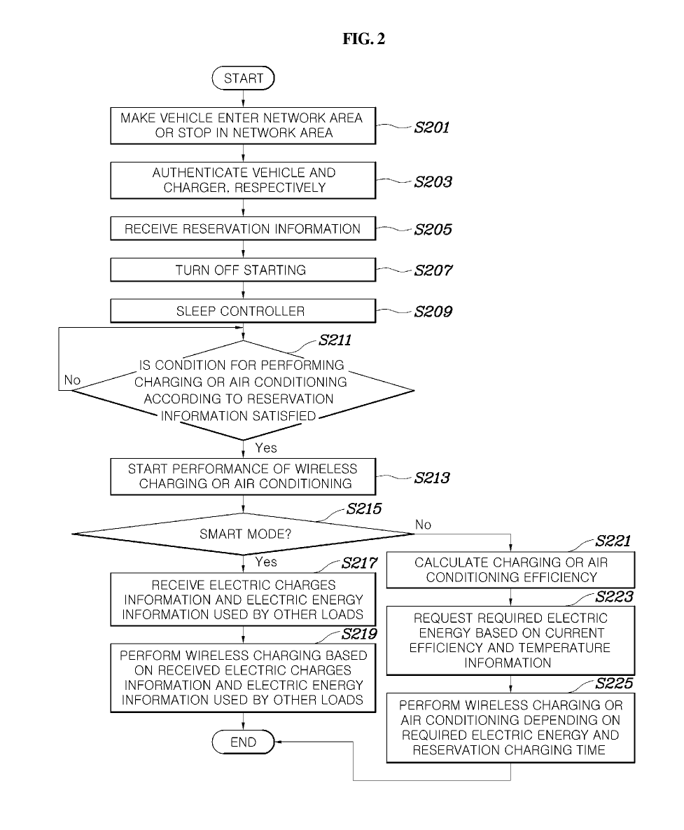

FIG. 1 is an exemplary diagram schematically illustrating a system for controlling electric vehicles according to an exemplary embodiment of the present invention. FIG. 2 is an exemplary flow chart illustrating a method for controlling electric vehicles according to an exemplary embodiment of the present invention.

Referring to FIG. 1, a controller may be configured to authenticate the vehicle and the charger using preset identifiers by sensing when a vehicle enters a network area of a charger, which may be disposed in, for example, a garage of a house.

Referring to FIG. 2, the processes may be performed by a controller which may be disposed within the vehicle. A method for controlling electric vehicles according to an exemplary embodiment of the present invention may include: authenticating, by the controller, a vehicle and a charger via wireless communication (S203) when the vehicle enters a network area of the charger or stops in the network area (S201); receiving, by the controller, reservation information (S205) set from the charger and the vehicle, respectively, when authentication is completed ; and performing, by the controller, wireless charging or air conditioning based on the received reservation information (S213 to S225).

Wireless communication may be performed by Wibro, high speed downlink packet access (HSDPA)/WCDMA, WiFi, or WiMax, but is not limited thereto. Further, when the reservation information is received, the reservation information may be transferred by Controller Area Network (CAN) communication.

In particular, a controller may be configured to the reservation information set from the charger and the vehicle, respectively and then disable an ignition of the vehicle prior to performing charging or air conditioning (S207). When the ignition of the vehicle is disabled, the controller may be configured to enter a sleep state (S209). In this state, the controller may be configured to determine whether charging or air conditioning conditions are satisfied based on received reservation information (S211).

In other words, for example, the reservation information received from the charger and the vehicle may include information regarding the performance charging or air conditioning, start time of the charging or air conditioning, charging completion time, required temperature information, and the like. When the information received from the charger and the vehicle is different, the action performed may be determined by priority information. The priority information may be preset by a driver and may be preset to prioritize the reservation information of the vehicle over the reservation information of the charger or vice versa. Further, when the reservation information from the vehicle is regarding charging and the reservation information from the charger is regarding air conditioning, either may be first performed based on driver reservation information priority.

For example, when the reservation charging time set from the vehicle is one o'clock and the reservation charging time set from the charger is two o'clock, when the driver prioritizes the reservation information from the vehicle, the charging may start at one o'clock. In another example, when the vehicle transmits charging reservation information and the charger transmits air conditioning reservation information, when the driver prioritizes the reservation information from the vehicle, the reservation charging may be performed. Further, the controller may be configured to prioritize the information received most recently. In other words, the controller may be configured to perform the wireless charging or air conditioning later based on the receiving time of the reservation information.

After the controller receives the reservation information, when the vehicle is in the disabled ignition state and the starting condition is satisfied (S211), the controller may be configured to perform the wireless charging or air conditioning based on the received reservation information (S213). The starting condition may include a condition regarding whether the vehicle is in a reservation charging time or a reservation air conditioning time, a condition regarding whether the battery is charged less than a preset level, and the like.

Meanwhile, after the controller receives the reservation information, when the vehicle is beyond (e.g., outside the range of) the network area and then reenters the network area, the controller may be configured to perform the wireless charging or air conditioning based on the previously received reservation information. However, when the reservation information is updated, the controller may be configured to perform the wireless charging or air conditioning of the vehicle based on the updated reservation information.

Further, the controller may be configured to determine whether an operation mode preset by the driver is a normal mode or a smart mode after the wireless charging or air conditioning starts (e.g., when the vehicle reaches charging start time, air conditioning start time or the battery is charged less than a preset level, the wireless charging or air conditioning starts to perform) (S215). The controller may be configured to receive required information from the charger and the vehicle based on the preset operation modes. The required information may include at least one of an external temperature, a charging efficiency, a required current and voltage, an electricity usage by other electric devices using the same power source as the charger, a midnight electricity availability, a maximum charging current information, and a required charging time.

When the operation mode is set to normal mode, the controller may be configured to calculate the wireless charging efficiency by dividing the electrical energy supplied to the vehicle by the required electrical energy transferred from the vehicle to the charger and electrical energy used to charge the vehicle (S221). The controller may be configured to request a required electrical energy for air conditioning or charging based on the calculated wireless charging efficiency and the current temperature information of the vehicle (S223). Further, the wireless charging and air conditioning may be performed with the required electrical energy (S225).

When the operation mode is set to be the smart mode, the controller may be configured to receive information regarding electrical charge, electricity usage of other electrical devices using the same power source, midnight electricity availability, maximum charging current, and the like from the charger (S217). The controller may be configured to perform the charging or air conditioning based on the received information after the electrical energy used by other loads is less than the preset electrical energy by delaying the performance of charging or air conditioning when the electrical energy used by other loads exceeds the preset electrical energy. Alternatively, the charging may be performed by selecting the time when electrical charges are minimal. For example, the charging may be performed at midnight depending on the price of electricity used at midnight and the air conditioning may be performed depending on the reservation air conditioning time (S219). The charging and air conditioning conditions in smart mode may be transmitted to a cellular phone or a personal computer (PC) of the driver.

According to an exemplary embodiment of the present invention, the method and the system for controlling electric vehicles may allow the vehicle and the charger to share the reservation information set, by recognizing when the vehicle stops in a charging pad and enters the network area of the charger.

It may be possible to adjust the reservation charging time, the charging amount, and the like of the vehicle by receiving information such as the set charging start time and end time, external temperature, the charging efficiency, and the like from the vehicle, and midnight electricity availability, the electrical charge information, the electrical energy information used by other loads, and the like from the charger. It may be possible for the charger to adjust the electrical energy consumed to charge the vehicle based on electrical energy used by other loads.

It may also be possible to perform the air conditioning of the vehicle while charging at the maximum efficiency based on the operation mode set by the driver. Further, it may be possible to lower expenses by charging the vehicle when electrical charges are minimized while reflecting the savings based on the operation mode set by the driver.

Although the present invention has been described with reference to the exemplary embodiments shown in the accompanying drawings, they are only examples. It will be appreciated by those skilled in the art that various modifications and equivalent other embodiments are possible from the present invention. Accordingly, an actual technical protection scope of the present invention is to be defined by the following claims.

What is claimed is:

1. A method for controlling vehicles, comprising:
authenticating, by a controller, a vehicle and a charger wirelessly when the vehicle enters or stops in a network area of the charger;
receiving, by the controller, a reservation information set from the charger and the vehicle when the authentication is completed; and
performing, by the controller, wireless charging or air conditioning based on the received reservation information set.

2. The method of claim 1, wherein the performing of the wireless charging or air conditioning is performed based on at least one selected from the group consisting of: a priority of the reservation information received from the charger and the vehicle, and receiving time of the reservation information.

3. The method of claim 2, wherein the priority is changed depending on a preset priority.

4. The method of claim 1, wherein in the wireless authentication of the vehicle and the charger, the vehicle and the charger are both authenticated based on preset identifiers.

5. The method of claim 1, wherein the performing of the wireless charging or air conditioning includes:
receiving, by the controller, required information from the charger and the vehicle based on to preset operation modes after the wireless charging or air conditioning is performed.

6. The method of claim 5, wherein the required information includes at least one selected from the group of: an external temperature, a charging efficiency, a required current and voltage, an electricity usage of other electrical devices using the same power source as the charger, a midnight electricity availability, a maximum charging current amount, and a required charging time.

7. The method of claim 1, wherein the reservation information received from the authenticated vehicle and the charger includes at least one selected from the group of: initial state of charge (SOC) information and reservation time information.

8. The method of claim 1, further comprising:
disabling, by the controller, an ignition of the vehicle, after receiving the reservation information; and
performing, by the controller, the wireless charging or air conditioning based on the reservation information when a starting condition of the wireless charging or air conditioning is satisfied.

9. The method of claim 8, wherein the starting condition includes at least one selected from the group of: a condition regarding whether the vehicle is in a reservation charging time and a condition regarding whether a battery is charged less than a preset level.

10. The method of claim 1, further comprising:
performing, by the controller, the wireless charging or air conditioning based on the reservation information received when the vehicle reenters the network area of the charger.

11. The method of claim 1, wherein the performing of the wireless charging or air conditioning of the vehicle includes:
calculating, by the controller, wireless charging efficiency using electrical energy supplied to the vehicle divided by required electrical energy transferred from the vehicle to the charger and electrical energy used to charge the vehicle.

12. The method of claim 11, wherein the performing of the wireless charging or air conditioning of the vehicle further includes:
retransmitting, by the controller, required electrical energy determined based on the calculated wireless charging efficiency and temperature of the vehicle.

13. The method of claim 1, wherein the performing of the wireless charging or air conditioning is performed by adjusting performance time of the wireless charging and electrical energy used during the wireless charging or air conditioning based on received electrical charges information from the charger or electrical energy information used by other loads.

14. A system for controlling electric vehicles, comprising: a charger having a network area to wirelessly communicate with a vehicle and configured to charge the vehicle; and
a controller configured to:
receive an input command;
execute communication between the vehicle and the charger;
execute wireless charging and air conditioning of the vehicle;
authenticate the vehicle and the charger when the vehicle enters or stops in the network area; and
receive reservation information set from the charger and the vehicle, when the authentication is completed to execute the wireless charging and air conditioning of the vehicle.

15. The system for controlling electric vehicles of claim 14, wherein the wireless charging and air conditioning is executed based on at least one selected from the group consisting of: a priority of the reservation information received from the charger and the vehicle, and receiving time of the reservation information.

16. The system for controlling electric vehicles of claim 15, wherein the priority is changed based on a preset priority.

17. A non-transitory computer readable medium containing program instructions executed by a controller, the computer readable medium comprising:
program instruction that receive and input command;
program instructions that execute communication between a vehicle and a charger;
program instructions that execute wireless charging and air conditioning of the vehicle;
program instructions that authenticate the vehicle and the charger when the vehicle enters or stops in the network area; and
program instructions that receive reservation information set from the charger and the vehicle, when the authentication is completed to execute the wireless charging and air conditioning of the vehicle.

18. The non-transitory computer readable medium of claim 17, wherein the wireless charging and air conditioning is executed based on program instructions that execute charging and air conditioning based on at least one selected from the group of: a priority of the reservation information received from the charger and the vehicle, and receiving time of the reservation information.

19. The non-transitory computer readable medium of claim 18, wherein the priority is based on program instructions that change the priority based on a preset priority.
